(19) United States
(12) Patent Application Publication
(10) Pub. No.: US 2013/0223120 A1
(43) Pub. Date: Aug. 29, 2013

(54) METHOD AND APPARATUS FOR ACTIVE INRUSH CONTROL OF BOOST POWER STAGE

(71) Applicant: Murata Manufacturing Co., Ltd., (US)

(72) Inventors: Milan DRAGOJEVIC, Chestnut Hill, MA (US); Anthony LONG, Marlborough, MA (US)

(73) Assignee: MURATA MANUFACTURING CO., LTD., Nagaokakyo-shi (JP)

(21) Appl. No.: 13/780,920

(22) Filed: Feb. 28, 2013

Related U.S. Application Data
(60) Provisional application No. 61/604,690, filed on Feb. 29, 2012.

(51) Int. Cl. H02M 7/06

(52) U.S. Cl. CPC H02M 7/06
USPC 363/126

(57) ABSTRACT

A power stage includes an input voltage source; an inductor including first and second windings, where the first winding is connected to the input voltage source and where the second winding is magnetically coupled to the first winding; an output capacitor; a first diode connected to the first winding; a second diode connected between the second winding and the output capacitor; a boost switch connected to the first winding; and a control switch connected between the first diode and the output capacitor. The control switch is arranged to actively control inrush current during start-up of the power stage. A method of controlling inrush current of a boost power stage includes actively controlling the inrush current of the power stage by controlling a control switch through which the inrush current during start-up flows.

### BACKGROUND OF THE INVENTION

1. Field of the Invention

The present invention relates to power conversion. More specifically, the present invention relates to AC/DC and DC/DC power conversion.

2. Description of the Related Art

Inrush current is the current in a power stage during the start-up of the power stage. FIG. 1 shows a known boost power stage. The voltage from input source V1 is rectified by input bridge diodes D1, D2, D3, D4. The rectified voltage Vin is boosted using inductor L1 and is provided to capacitor C1. The control circuit M1 is used to turn the switch Q1 on and off through the driver M2. The control circuit M1 operates the switch Q1 in boost mode to increase the rectified voltage Vin. During start-up, current flows through bypass diode D6 to charge the capacitor C1. After start-up, the current flows through the inductor L1. Without bypass diode D6, it is possible to damage the boost power stage during start-up. After start-up and when the capacitor C1 is charged to a voltage above the voltage of the input source V1, the boost power stage can be regulated to control the output voltage at Vout.

Inrush current in this known boost power stage can be very high. As shown in FIG. 1, known boost power stages use a thermistor RT1 connected in series at the input of the boost power stage. Most of the inrush current is dissipated across the thermistor RT1 during start-up, and during normal operation, the dissipation becomes smaller as the thermistor RT1 warms up.

Thus, the thermistor RT1 is an inrush-current limiting device. The dashed line in FIG. 1 represents the inrush current during the start-up of the boost power stage. The resistance of the thermistor RT1 limits the current. After the capacitor C1 is charged, the control circuit M1 starts the boost power stage. Because the thermistor RT1 has a negative temperature coefficient, the resistance of the thermistor RT1 decreases as its temperature increases. Because the resistance of the thermistor RT1 decreases with increasing temperature, the power loss generated by the thermistor RT1 decreases as the temperature of the thermistor RT1 increases. This conventional boost power stage has the drawback of having power losses during normal operation. The power losses are significant for higher power or if a large output capacitor C1 is used.

If the input voltage is applied directly, without using an inrush-current limiting device, such as the negative temperature coefficient (NTC) thermistor RT1 shown in FIG. 1, the current can be very high and is only limited by the low internal resistance of elements in the boost power stage. This high current can trigger the current protection device such as fuse F1 shown in FIG. 1.

FIG. 2 shows another known boost power stage in which the known boost power stage shown in FIG. 1 has been modified by adding a bi-directional mechanical relay S1 across the thermistor RT1. This relay S1 is switched on after the boost power stage has been turned on and when the boost power stage has achieved normal operation (i.e., when it has achieved steady-state operation), bypassing the highly dissipative thermistor RT1.

In FIG. 2, the inrush-current limiting device is the combination of a relay S1 and a thermistor RT1. The principle of operation of this known boost power stage is the same as the known boost power stage shown in FIG. 1. The relay S1 added in parallel with thermistor RT1 is activated after capacitor C1 is charged. The relay S1 decreases the power losses during normal operation. After the relay S1 is activated, the control circuit M1 starts the boost power stage.

Some of the problems with the inrush-current limiting device in FIG. 2 are that relay S1 is bulky and takes up valuable space.

In addition, known boost power stages such as those shown in FIGS. 1 and 2 do not provide protection against short circuits or overload conditions.

### SUMMARY OF THE INVENTION

To overcome the problems described above, preferred embodiments of the present invention provide a power stage that can actively control the inrush current during start-up.

A power stage according to a preferred embodiment of the present invention includes an input voltage source; an inductor including first and second windings, where the first winding is connected to the input voltage source and where the second winding is magnetically coupled to the first winding; an output capacitor; a first diode connected to the first winding; a second diode connected between the second winding and the output capacitor; a boost switch connected to the first winding; and a control switch connected between the first diode and the output capacitor. The control switch is arranged to actively control inrush current during start-up of the power stage.

The power stage preferably further includes a second inductor including third and fourth windings, where the third winding is connected to a terminal of the input voltage source that the first winding is not connected to and where the fourth winding is magnetically coupled to the third winding; a third diode connected to the third winding; a fourth diode connected between the fourth winding and the output capacitor; and a second boost switch connected to the third winding. The control switch is preferably connected between the third diode and the output capacitor.

The inductor preferably includes a third winding that is connected to a terminal of the input voltage source that the first winding is not connected to. The power stage preferably further includes a second inductor including fourth, fifth, and sixth windings, where the fourth winding is connected to the first winding, where the fifth winding is connected to the second winding, and where the sixth winding is connected to the third winding; a third diode connected to the fifth winding; a fourth diode connected between the sixth winding and the output capacitor; and a second boost switch connected to the fifth winding. The control switch is preferably connected between the third diode and the output capacitor.

The power stage preferably further includes a mode of operation selection circuit arranged to select between normal operation mode and inrush control mode. In the normal operation mode, the boost switch is preferably turned on and off and the control switch is preferably turned on. The inrush control mode preferably includes a flyback mode and a forward mode. In the flyback mode, the boost switch is preferably turned on and off and the control switch is preferably off. In the forward mode, the boost switch is preferably off and the control switch is preferably turned on and off.

The power stage preferably further includes a sense resistor that is arranged to sense the current through the inductor. The input voltage source preferably includes an AC voltage source providing an AC voltage and a rectifying circuit connected to the AC voltage source that provides a DC voltage output. The first and second windings preferably have an equal number of turns. The power stage preferably further includes a fuse connected to the input voltage source.

A power stage according to another preferred embodiment of the present invention includes an input voltage source; an inductor including first and second windings, where the first winding is connected to the input voltage source and where the second winding is magnetically coupled to the first winding; an output capacitor; a first diode connected to the first winding; a second diode connected between the second winding and the output capacitor; a boost switch connected to the first winding; and a control switch connected between the boost switch and ground. The control switch is arranged to actively control inrush current during start-up of the power stage.

A method of controlling inrush current of a boost power stage according to a further preferred embodiment of the present invention includes actively controlling the inrush current of the power stage by controlling a control switch through which the inrush current during start-up flows.

The method is preferably used with a boost power stage that includes an input voltage source; an inductor including first and second windings, where the first winding is connected to the input voltage source and where the second winding is magnetically coupled to the first winding; an output capacitor; a first diode connected to the first winding; a second diode connected between the second winding and the output capacitor; and a boost switch connected to the first winding. The control switch is preferably connected between the first diode and the output capacitor.

The method is preferably used with a power stage that further includes a second inductor including third and fourth windings, where the third winding is connected to a terminal of the input voltage source that the first winding is not connected to and where the fourth winding is magnetically coupled to the third winding; a third diode connected to the third winding; a fourth diode connected between the fourth winding and the output capacitor; and a second boost switch connected to the third winding. The control switch is preferably connected between the third diode and the output capacitor.

The method is preferably used with a power stage in which the inductor preferably includes a third winding that is connected to a terminal of the input voltage source that the first winding is not connected to.

The method is preferably used with a power stage that preferably further includes a second inductor including fourth, fifth, and sixth windings, where the fourth winding is connected to the first winding, where the fifth winding is connected to the second winding, and where the sixth winding is connected to the third winding; a third diode connected to the fifth winding; a fourth diode connected between the sixth winding and the output capacitor; and a second boost switch connected to the fifth winding. The control switch is preferably connected between the third diode and the output capacitor.

The method is preferably used with a power stage in which a terminal of the control switch is connected to ground.

The above and other features, elements, characteristics, and advantages of the present invention will become more apparent from the following detailed description of preferred embodiments of the present invention with reference to the attached drawings.

### BRIEF DESCRIPTION OF THE DRAWINGS

FIG. 1 shows a known boost power stage.

FIG. 2 shows a known boost power stage in which the inrush current limiting device is the combination of a relay S1 and a thermistor RT1.

FIG. 3 shows a circuit diagram of a power stage according to a first preferred embodiment of the present invention.

FIG. 4 shows the start-up of the power stage shown in FIG. 3 in flyback mode.

FIG. 5 shows waveforms used in the flyback mode shown in FIG. 4.

FIG. 6A shows the boost mode of the power stage shown in FIG. 3.

FIG. 6B shows the forward operation mode of the power stage shown in FIG. 3.

FIG. 7 shows waveforms used in the boost mode and in the forward mode.

FIG. 8 shows a simplified circuit that can be used for the mode of operation selection circuit according to a preferred embodiment of the present invention.

FIG. 9 shows a circuit diagram of a power stage according to a second preferred embodiment of the present invention.

FIG. 10 shows a known bridgeless boost converter with return diodes.

FIG. 11 shows a circuit diagram of a power stage according to a third preferred embodiment of the present invention.

FIG. 12 shows a known dual-core bridgeless boost converter with return diodes.

FIG. 13 shows a circuit diagram of a power stage according to a fourth preferred embodiment of the present invention.

### DETAILED DESCRIPTION OF PREFERRED EMBODIMENTS

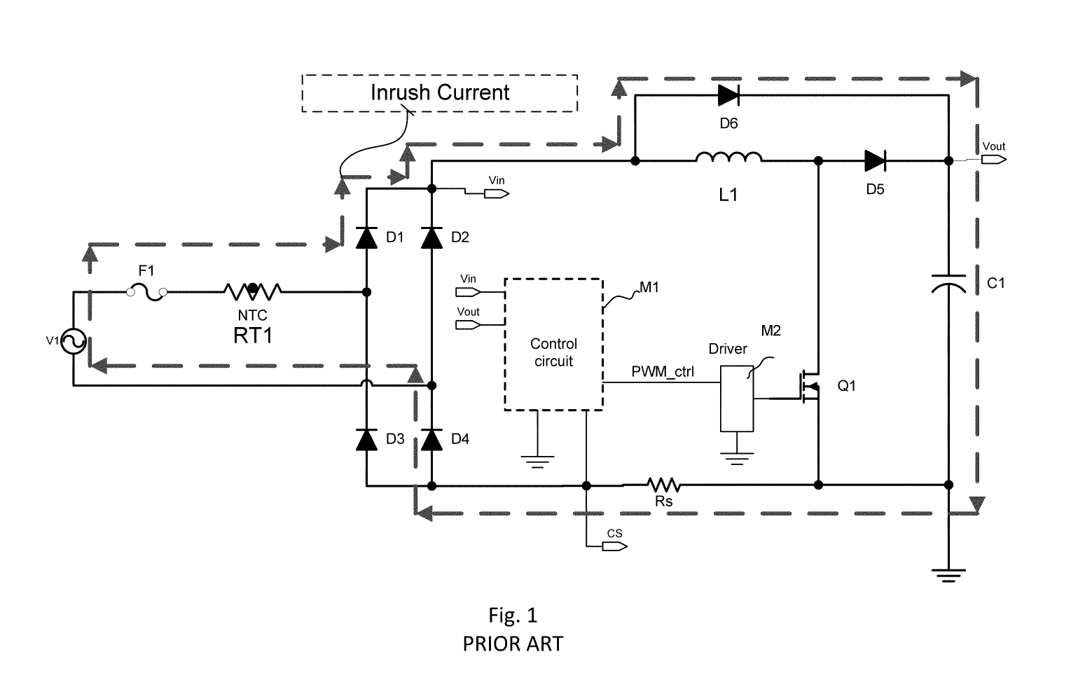

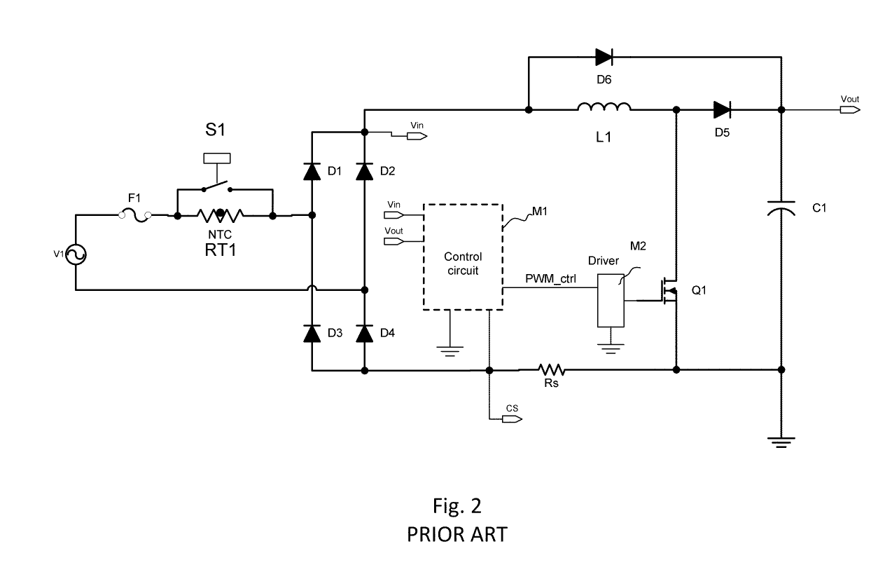

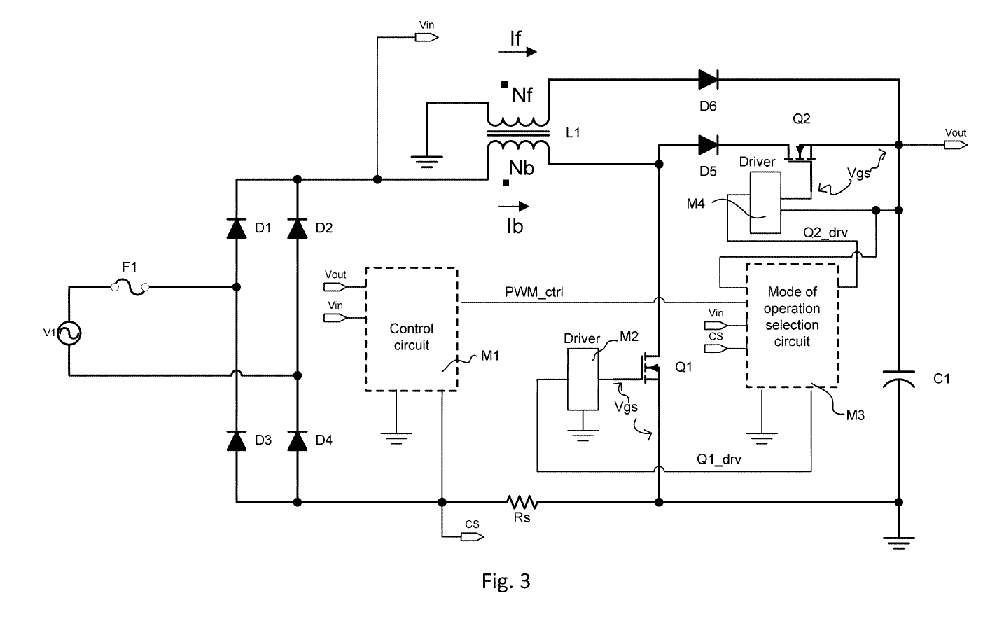

Preferred embodiments of the present invention will now be described with reference to FIGS. 3-9, 11, and 13. In the preferred embodiments of the present invention, the inrush current is actively controlled. For example, as shown in FIG. 3, the inrush current can be actively controlled by the switch Q2 connected in series with boost diode D5. Known techniques for controlling the inrush use passive components (e.g., thermistor RT1 shown in FIGS. 1 and 2) that only reduce the peak of the inrush current during start-up. In contrast, preferred embodiments of the present invention actively control the inrush current during start-up.

The power loss in the preferred embodiments of the present invention is less than the power loss in either the arrangement including just the thermistor RT1 as shown in FIG. 1 or the arrangement including the relay S1 and the thermistor RT1 as shown in FIG. 2. For example, power losses on the switch Q2 with a resistance of 100 mΩ preferably is 0.625 W for a 1 kW boost power stage with input voltage 100 VAC and output voltage of 400 VDC, for example. Under the same conditions, a conventional relay S1 with a contact resistance of 20 mΩ has 0.5 W coil power losses and 2 W conduction losses so that the total power losses are 2.5 W.

The combined cost and size of the additional components of the preferred embodiments of the present invention are less than the cost and size of the known arrangements using the thermistor RT1 and the relay S1.

In the case of a short circuit at the output capacitor C1 or high over-load, the switches Q1 and Q2 are in the off state and the power stage is disconnected from input source V1.

Both techniques used in the known boost power stages shown in FIGS. 1 and 2 create unrecoverable losses during the start-up of the power stage because both techniques use a passive thermistor RT1 to limit the current. In contrast, preferred embodiments of the present invention use an active switch to control the inrush current. The power losses are minimized because an active PWM switching technique is used.

A first preferred embodiment of the present invention is shown in FIG. 3. The power-factor-correction (PFC) stage includes input bridge rectifier diodes D1, D2, D3, D4 coupled with inductor L1 including two windings Nb, Nf, diodes D5, D6, switches Q1, Q2, output capacitor C1, current sense resistor Rs, control circuit M1, driver M2, driver M4, and mode of operation selection circuit M3. Instead of using the sense resistor Rs shown in FIG. 1, it is possible to use other techniques to measure or estimate the input current. The control circuit M1 is preferably a pulse-width-modulation (PWM) control circuit. The single-winding inductor L1 in FIGS. 1 and 2 is replaced with a coupled inductor L1 with two windings Nb, Nf with the polarity preferably as shown in FIG. 3. Both windings Nb, Nf of the coupled inductor L1 preferably have an equal number of turns. The switch Q2 is connected in series with the boost diode D5. Diode D6 is a high-speed diode connected in series with the winding Nf. Switches Q1, Q2 are controlled with the control circuit M1 and the mode of operation selection circuit M3.

The power stage of the first preferred embodiment of the present invention has two modes of operations. The first mode is an inrush current control mode, and the second mode is a normal mode. During the inrush current control mode, the input current is limited and the output capacitor C1 is charged to the maximum peak input voltage provided by input source V1. There are two sub-modes of operations to control the inrush current during inrush current control mode. The first and preferable sub-mode is a flyback mode. The second sub-mode is a forward mode.

The mode of operation selection circuit M3 selects the mode of operation during the inrush current control mode. The mode of operation selection circuit M3 also changes the operation of the power stage from the inrush current control mode to the normal mode. The power stage operates in a boost mode in the normal mode. This mode is selected because the topology needed for boost mode has a minimum requirement for input filtering. The flyback and forward modes are selected because inrush current control is possible, while it is not in boost mode. It is possible for a user to select which of the flyback and forward modes is used during start-up. It is also possible that the mode of operation selection circuit M3 only provides either flyback mode or forward mode to control the inrush current. In the forward mode it is only possible to charge the capacitor C1 to a voltage that approaches the voltage of the input source V1. In the flyback mode it is possible to charge the capacitor C1 to a voltage that is higher than the voltage of the input source V1, which is why it is preferable in many applications to use the flyback mode over the forward mode.

Inrush Control Mode/Flyback Operation Mode

The inrush current control mode starts after connecting the input source V1 to the power stage.

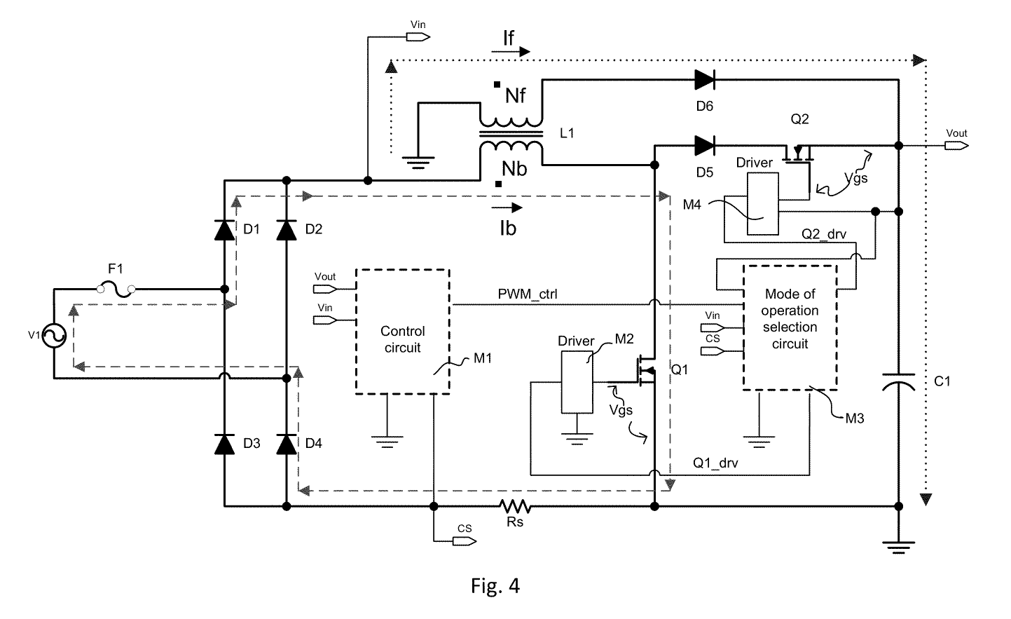

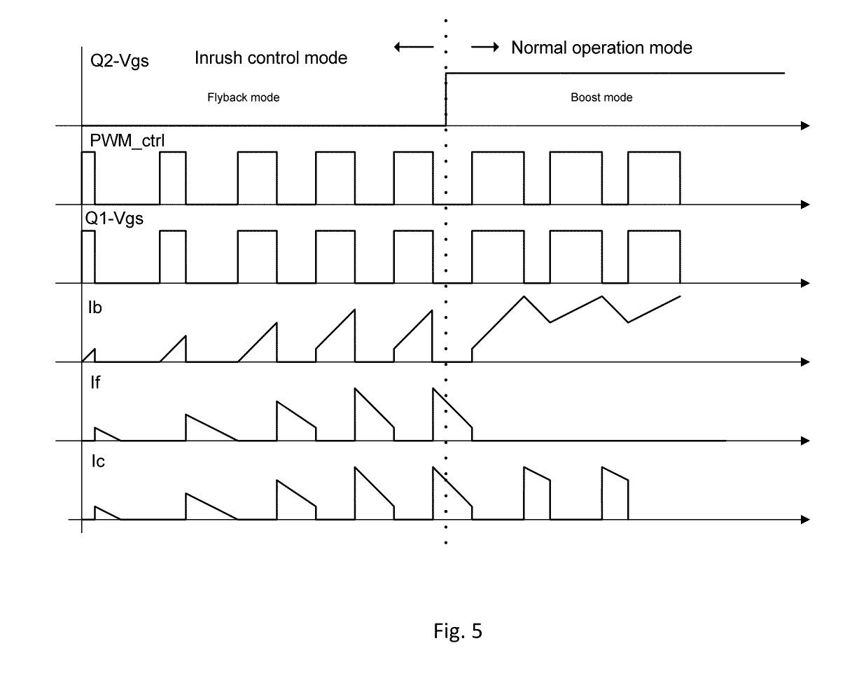

FIG. 4 shows the principle of operation of the start-up of the power stage in flyback mode. In this mode, diode D5 and switch Q2 are in the off state. The dashed line through switch Q1 represents the current during the on time of switch Q1. During the off time of the switch Q1, the energy stored in the inductor L1 is transferred to the output capacitor C1 via the winding Nf. The current during the off time of switch Q1 is represented by the dotted line through diode D6. FIG. 5 shows the waveforms used in the flyback mode. The waveform Q2-Vgs is the gate-to-source voltage on the switch Q2. The waveform PWM_ctrl is the PWM control signal generated by the control circuit M1. The waveform Q1-Vgs is the gate-to-source voltage on the switch Q1. The waveform 1b is the current through winding Nb of inductor L1. The waveform If is the current through winding Nf of inductor L1. The wave form 1c is the current through the output capacitor C1.

Normal Operation Mode/Boost Operation Mode

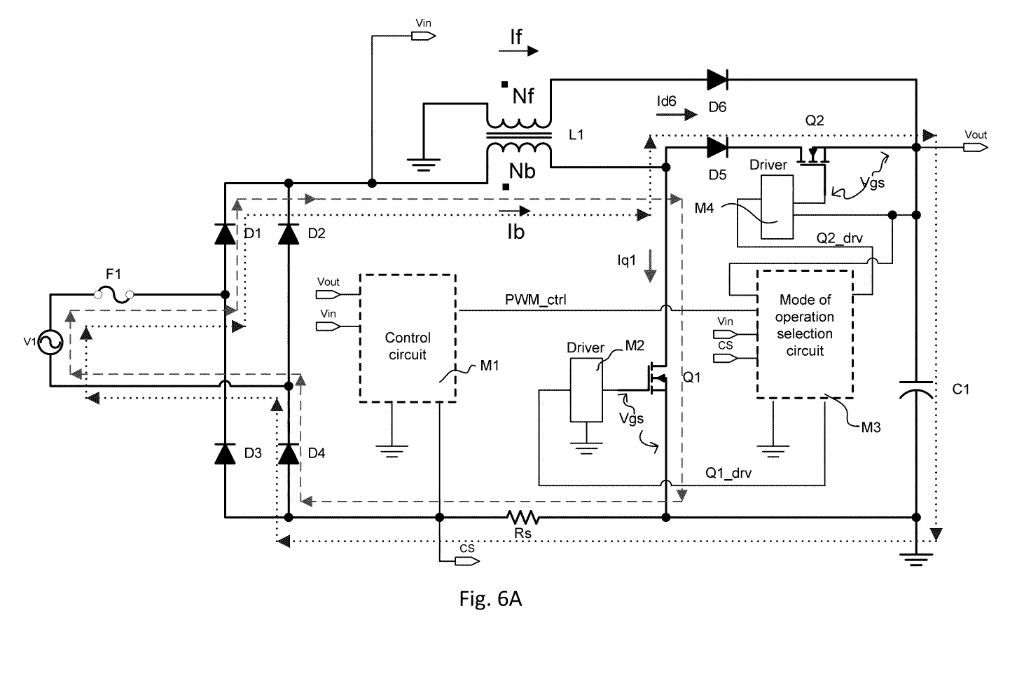

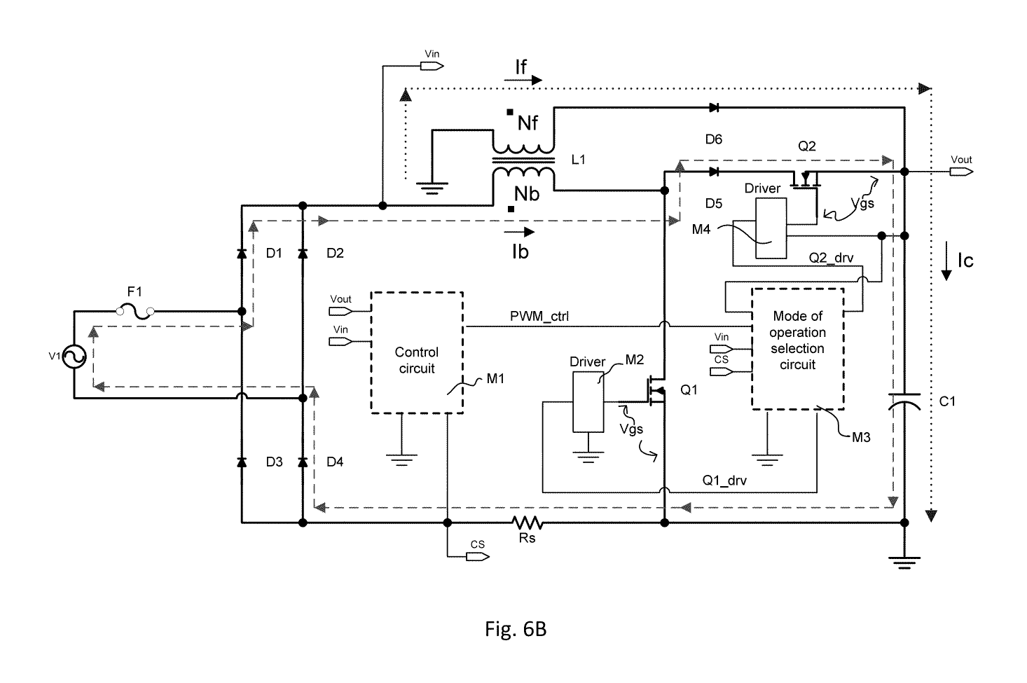

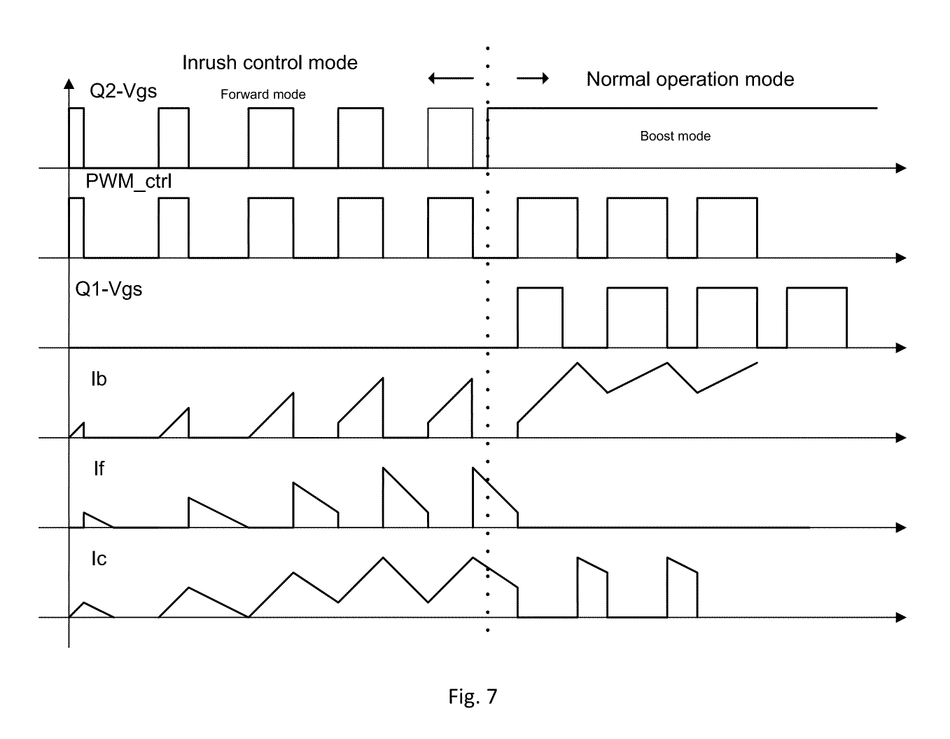

The power stage preferably changes modes from flyback mode to boost mode after the output capacitor C1 is charged to a voltage higher than the peak input voltage. The boost mode is shown in FIG. 6A. The diode D6 is reverse biased, and the switch Q2 is turned on all of the time. The dashed line through switch Q1 shown in FIG. 6A shows the current during the on time of the switch Q1. The current during the off time of the switch Q1 is shown by the dotted line in FIG. 6A. FIG. 7 shows waveforms used in the boost mode. The waveform Q2-Vgs is the gate-to-source voltage on switch Q2. The waveform PWM_ctrl is the PWM control signal generated by the control circuit M1. The waveform Q1-Vgs is the gate-to-source voltage on the switch Q1. The waveform 1b is the current through winding Nb of inductor L1. The waveform If is the current through winding Nf of inductor L1. The waveform 1c is the current through the output capacitor C1. In the boost mode it is possible to regulate the output voltage (i.e. at the capacitor C1) to a voltage higher than the voltage of the input source V1.

Inrush Control Mode/Forward Mode

FIG. 6B shows the principle of operation of the start-up of the power stage in the forward mode. In this mode, the switch Q1 is in the off state. The dashed line through sense resistor Rs represents the current during the on time of the switch Q2. This is the forward conduction time. During the off time of the switch Q2 (i.e., the free-wheeling period), the winding Nf is active. The current during the free-wheeling period is shown by the dotted line through diode D6. FIG. 7 shows, in addition to the waveforms used in the boost mode, waveforms used in the forward mode.

Mode of Operation Selection Circuit M3

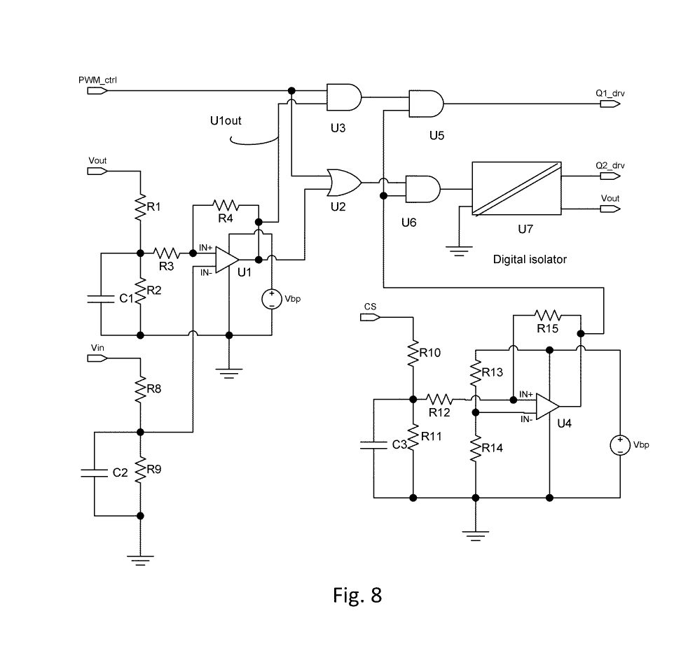

FIG. 8 shows an example of a simplified circuit that can be used for the mode of operation selection circuit M3. While FIG. 8 shows the implementation of a specific example of a mode of operation selection circuit, it is possible to use other circuits to achieve the same or similar functions as the mode of operation selection circuit M3 shown in FIG. 8. The mode of operation selection circuit M3 shown in FIG. 8 receives as inputs: input voltage Vin, output voltage Vout, PWM control signal PWM_ctrl, and inductor current signal CS measured at current sense resistor Rs and provides two control signal outputs: drive signals Q2_drv, Q1_drv. When the output voltage Vout is less than the input voltage Vin, the drive signal Q1_drv is in the logic state zero, which turns off the switch Q1. The drive signal Q2_drv follows the PWM control signal PWM_ctrl and drives the switch Q2. During start-up, the mode of operation selection circuit M3 preferably linearly charges the capacitor C1.

During high over-load or short-circuit condition, high over current is detected by current sense resistor Rs. The inductor current signal CS activates the comparator U4, which changes the state of the drive signals Q1_drv, Q2_drv. The drive signals Q1_drv, Q2_drv turn the switches Q1, Q2 off.

The filter capacitor C1 and the resistive divider including resistors R1, R2 are used to filter and scale the output voltage Vout. The filter capacitor C2 and the resistive divider including resistors R8, R9 are used to filter and scale the input voltage Vin. The input/output-voltage comparator U1 is used to compare input voltage Vin and output voltage Vout. Bias power supply Vbp provides a bias voltage for input/output-voltage comparator U2 and the circuit associated with the input/output-voltage comparator U2.

The input/output-voltage comparator U1 compares the scaled and filtered input voltage Vin and the output voltage Vout. The hysteresis is defined by resistors R3, R4. If the output voltage Vout is lower than the input voltage Vin, then the output signal U1 out of the input/output-voltage comparator U1 is in the logic state zero. If the output voltage Vout is higher than the input voltage Vin, then the output signal U1 out of the input/output-voltage comparator U1 is in the logic state one.

The filter capacitor C3 and the resistor divider including resistors R10, R11 are used to filter and scale the inductor current signal CS. The resistor divider including resistors R13, R14 sets the over-current protection threshold voltage. Bias power supply Vbp provides a bias voltage for over-current comparator U4 and the circuit associated with over-current comparator U4, which is used to set the over-current protection threshold voltage.

The over-current comparator U4 compares the scaled and filtered inductor current signal CS and the over-current protection threshold voltage. The hysteresis is defined by resistors R12, R15. If inductor current signal CS is lower than the over-current protection threshold voltage, then the output signal of the over-current comparator U4 is in the logic state zero. If the inductor current signal CS is higher than the over-current protection threshold voltage, then the output signal of the over-current comparator U4 is in the logic state one.

The PWM control signal PWM_ctrl and the output signal U1 out signals are input to the AND gate U3. The output of the AND gate U3 will follow the PWM control signal PWM-ctrl only if the output signal U1 out is in the logic state one.

The output of the AND gate U3 and the output of over-current comparator U4 are connected to the input of the AND gate U5. The drive signal Q1_drv, which is the output of the AND gate U5, follows the PWM control signal PWM_ctrl if the output of the over-current comparator U4 and the output signal U1 out are in the logic state one. This allows switching of the switch Q1 only if the output voltage Vout is higher or equal to the input voltage and the over-current protection is not activated.

The switching of the switch Q2 is also controlled by the input/output-voltage comparator U1 and the over-current comparator U4. The outputs from the input/output-voltage comparator U1 and the over-current comparator U4 are also connected to the OR gate U2 and the AND gate U6 to create the drive signal Q2_drv. The drive signal Q2_drv follows the PWM control signal PWM_ctrl if both the output signal U1 out and the output of the over-current comparator U4 are in the logic state zero. If output signal U1 out is in the logic state one (i.e., when the output voltage Vout is higher than the input voltage Vin), the drive signal Q2_drv is in logic state one and the switch Q2 is in the on state. The drive signal Q2_drv is in the off state if the output of over-current comparator U4 is in logic state zero. In this case both switches Q1, Q2 are off.

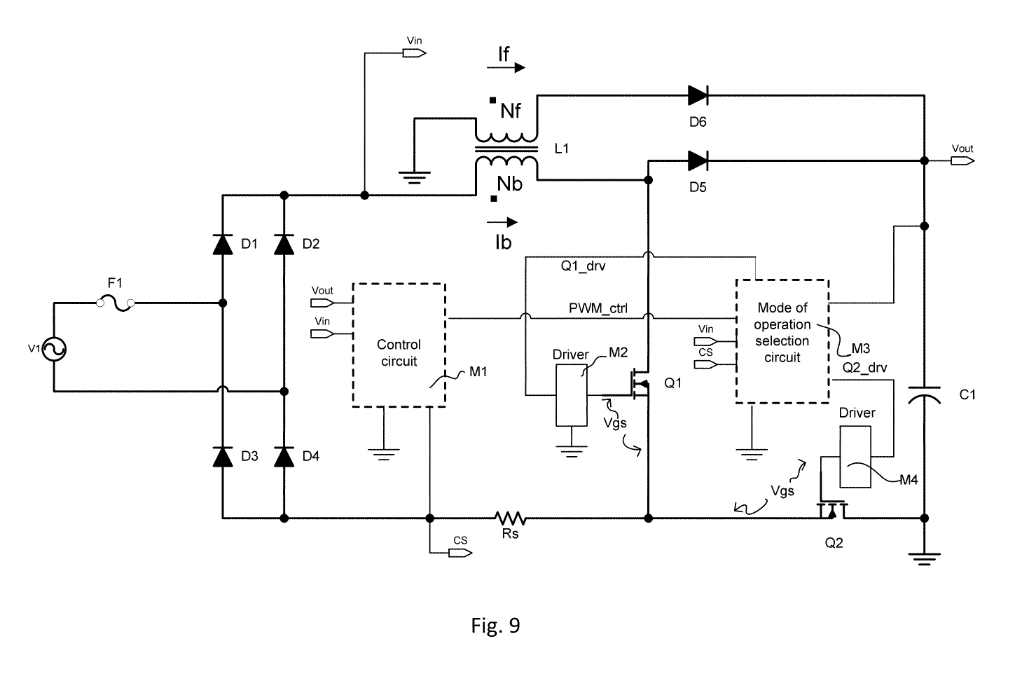

The output of the AND gate U6 is preferably connected to a digital isolator U7 that provides the drive signal Q2_drv. However, an opto-coupler, pulse transformer, or high-side drivers can be used instead of the digital isolator U7 shown in FIG. 8. It is also possible to not to use any isolator, for example, in the second preferred embodiment shown in FIG. 9.

The first preferred embodiment of the present invention is not limited to addressing the inrush current problem in PFC applications. The power stage of the first preferred embodiment of the present invention can also operate in three different modes: flyback, boost, and forward. Normally, the boost mode is used as a power factor correction circuit and to provide voltage for a downstream converter. The output voltage is higher than the highest peak input voltage, which is typically 400 VDC, for example. The input voltage is typically a single phase 85 VAC to 240 VAC, for example. The first preferred embodiment of the present invention can be used to create voltages lower than 400 VDC, for example 200 VDC. The mode of operation selection circuits can be the same. The only change required is changing the reference voltage for the output voltage setting.

The switch Q2 and the diode D6 can be connected to the ground return instead of to the positive side of the output capacitor C1 as shown in FIG. 9, which shows a second preferred embodiment of the present invention. The benefit of locating the switch Q2 in the ground return is convenient drive of both switches Q1, Q2 because both sources of the switches Q1, Q2 are connected to the same ground return.

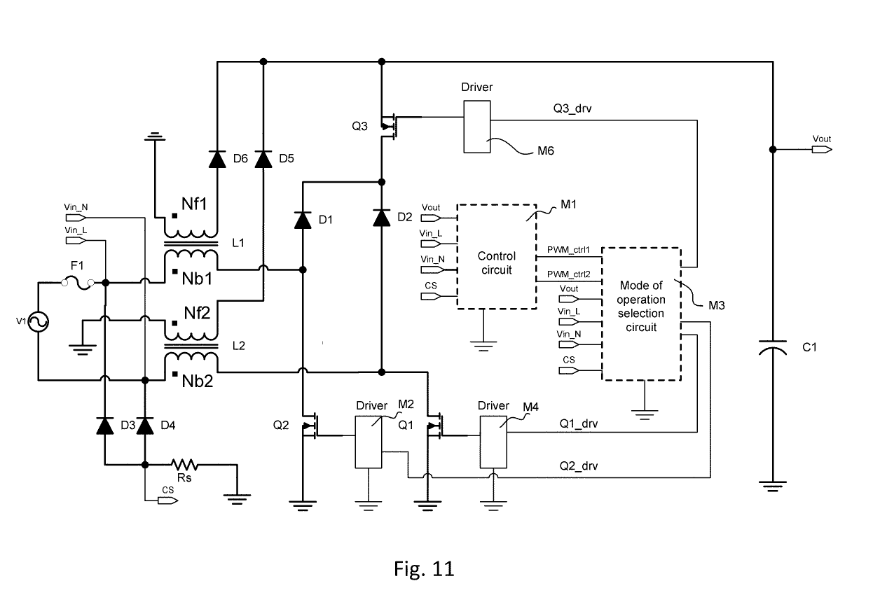

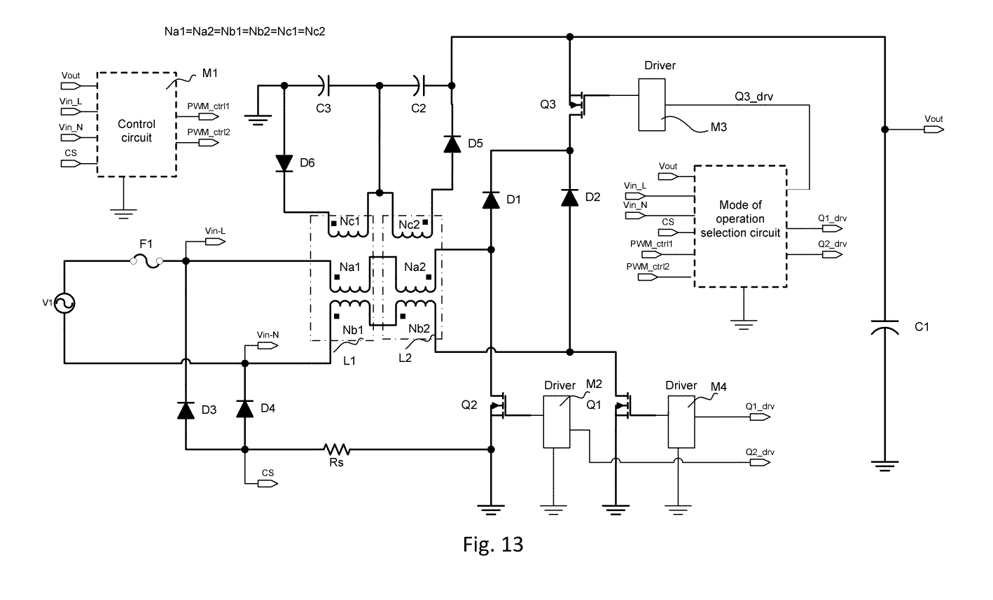

Possible implementations of active inrush control circuits for bridgeless boost topologies are shown in FIGS. 11 and 13.

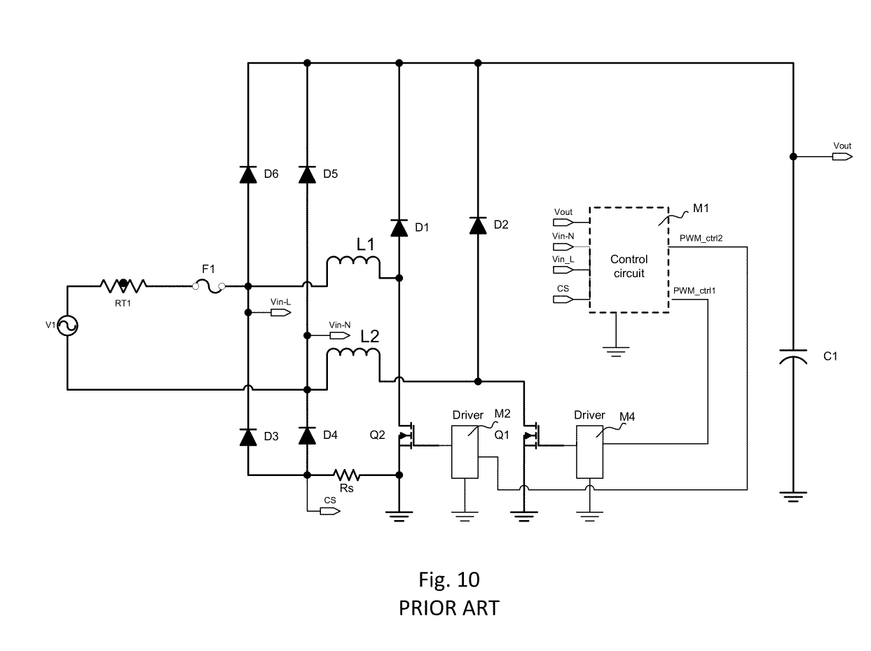

FIG. 10 shows a known bridgeless boost converter with noise-reduction diodes D3, D4. The bridgeless boost converter does not include any rectifying diodes similar to the bridge diodes D1, D2, D3, D4 in FIG. 1. Because the input voltage is not rectified, the bridgeless boost converter can be considered to be two boost converters connected in parallel. One boost converter providing boost when the voltage provided by input source V1 is positive and one boost converter providing boost when the voltage provided by input source V1 is negative. The inductors L1, L2 and the boost diodes D1, D2 in FIG. 10 correspond to the inductor L1 and the boost diode D5 in FIG. 1. In additional, the bypass diodes D5, D6 in FIG. 10 correspond to the boost diode D6 in FIG. 1. The NTC resistor RT1 and the bypass diodes D5, D6 are used for current inrush control.

FIG. 11 shows a third preferred embodiment of the present invention for the bridgeless boost converter shown in FIG. 10. The passive inrush control NTC resistor RT1 is replaced with switch Q3 arranged to control the inrush current using the active inrush control techniques according to the preferred embodiments of the present invention discussed above.

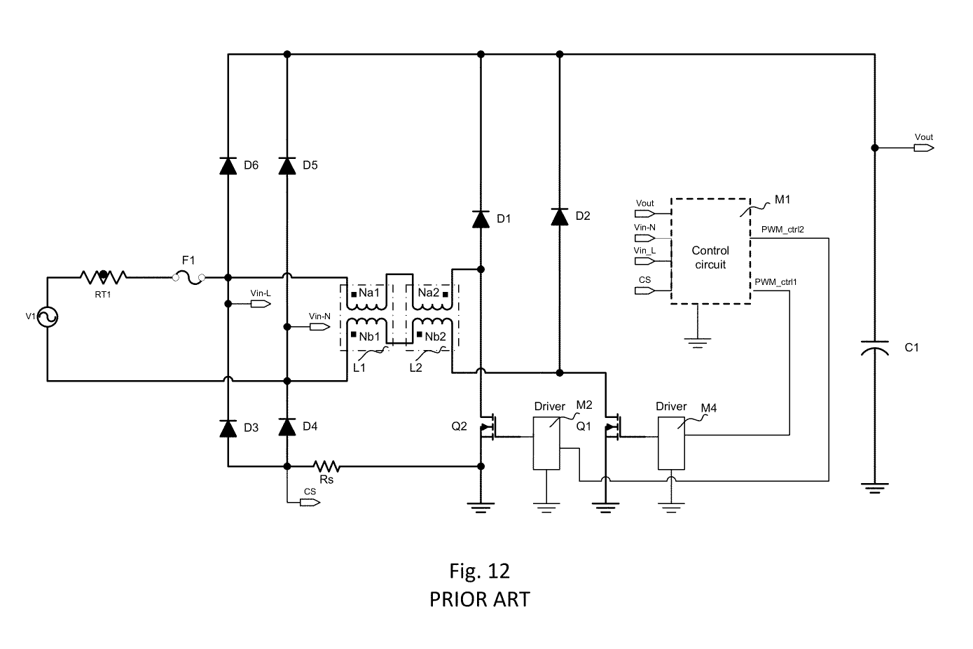

FIG. 12 shows a known dual-core bridgeless boost converter with noise-reduction diodes D3, D4. As with the bridgeless boost converter shown in FIG. 10, this bridgeless boost converter can be considered to be two boost converters connected in parallel. The bridgeless boost converter in FIG. 12 uses dual-core inductors L1, L2 in place of the inductors L1, L2 in FIG. 10. The dual-core inductors L1, L2 are smaller than the inductors L1, L2. The NTC resistor RT1 and the bypass diodes D5, D6 are used for inrush control.

FIG. 13 shows a fourth preferred embodiment of the present invention for the bridgeless dual-core boost converter shown in FIG. 12. The NTC resistor RT1 is replaced with a switch Q3 arranged to control the inrush current using the active inrush control techniques according to the preferred embodiments of the present invention discussed above. The dual-core inductors L1, L2 each include three windings. For each of the dual-core inductors L1, L2, one winding Na1, Na2 is connected to one terminal of the input source V1, one winding Nb1, Nb2 is connected to the other terminal of the input source V1, and one winding Nc1, Nc2 magnetically coupled to the other windings Na1, Na2, Nb1, Nb2. The windings Nc1, Nc2 are center tap and are connected diodes D5, D6 and capacitors C2, C3. The capacitors C2, C3 are connected in series so that the addition of voltage across the capacitors C2, C3 is supplied to the capacitor C1.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A power stage comprising:
an input voltage source;
an inductor including first and second windings, where the first winding is connected to the input voltage source and where the second winding is magnetically coupled to the first winding;
an output capacitor;
a first diode connected to the first winding;
a second diode connected between the second winding and the output capacitor;
a boost switch connected to the first winding; and
a control switch connected between the first diode and the output capacitor; wherein the control switch is arranged to actively control inrush current during start-up of the power stage.

2. A power stage according to claim 1, further comprising:
a second inductor including third and fourth windings, where the third winding is connected to a terminal of the input voltage source that the first winding is not connected to and where the fourth winding is magnetically coupled to the third winding;
a third diode connected to the third winding;
a fourth diode connected between the fourth winding and the output capacitor; and
a second boost switch connected to the third winding; wherein the control switch is connected between the third diode and the output capacitor.

3. A power stage according to claim 1, wherein the inductor includes a third winding that is connected to a terminal of the input voltage source that the first winding is not connected to.

4. A power stage according to claim 3, further comprising:
a second inductor including fourth, fifth, and sixth windings, where the fourth winding is connected to the first winding, where the fifth winding is connected to the second winding, and where the sixth winding is connected to the third winding;
a third diode connected to the fifth winding;
a fourth diode connected between the sixth winding and the output capacitor; and
a second boost switch connected to the fifth winding; wherein the control switch is connected between the third diode and the output capacitor.

5. A power stage according to claim 1, further comprising a mode of operation selection circuit arranged to select between normal operation mode and inrush control mode.

6. A power stage according to claim 5, wherein, in the normal operation mode, the boost switch is turned on and off and the control switch is turned on.

7. A power stage according to claim 5, wherein the inrush control mode includes a flyback mode and a forward mode.

8. A power stage according to claim 7, wherein, in the flyback mode, the boost switch is turned on and off and the control switch is off.

9. A power stage according to claim 7, wherein, in the forward mode, the boost switch is off and the control switch is turned on and off.

10. A power stage according to claim 1, further comprising a sense resistor that is arranged to sense the current through the inductor.

11. A power stage according to claim 1, wherein the input voltage source includes:
an AC voltage source providing an AC voltage; and
a rectifying circuit connected to the AC voltage source that provides a DC voltage output.

12. A power stage according to claim 1, wherein the first and second windings have an equal number of turns.

13. A power stage according to claim 1, further comprising a fuse connected to the input voltage source.

14. A power stage comprising:
an input voltage source;
an inductor including first and second windings, where the first winding is connected to the input voltage source and where the second winding is magnetically coupled to the first winding;
an output capacitor;
a first diode connected to the first winding;
a second diode connected between the second winding and the output capacitor;
a boost switch connected to the first winding; and
a control switch connected between the boost switch and ground; wherein the control switch is arranged to actively control inrush current during start-up of the power stage.

15. A method of controlling inrush current of a boost power stage comprising actively controlling the inrush current of the power stage by controlling a control switch through which the inrush current during start-up flows.

16. A method according to claim 15, wherein:
the boost power stage includes:
an input voltage source;
an inductor including first and second windings, where the first winding is connected to the input voltage source and where the second winding is magnetically coupled to the first winding;
an output capacitor;
a first diode connected to the first winding;
a second diode connected between the second winding and the output capacitor; and
a boost switch connected to the first winding; and
the control switch is connected between the first diode and the output capacitor.

17. A method according to claim 16, wherein the power stage further includes:
a second inductor including third and fourth windings, where the third winding is connected to a terminal of the input voltage source that the first winding is not connected to and where the fourth winding is magnetically coupled to the third winding;
a third diode connected to the third winding;
a fourth diode connected between the fourth winding and the output capacitor; and
a second boost switch connected to the third winding; wherein the control switch is connected between the third diode and the output capacitor.

18. A method according to claim 16, wherein the inductor includes a third winding that is connected to a terminal of the input voltage source that the first winding is not connected to.

19. A method according to claim 18, wherein the power stage further includes:
a second inductor including fourth, fifth, and sixth windings, where the fourth winding is connected to the first winding, where the fifth winding is connected to the second winding, and where the sixth winding is connected to the third winding;
a third diode connected to the fifth winding;
a fourth diode connected between the sixth winding and the output capacitor; and
a second boost switch connected to the fifth winding; wherein the control switch is connected between the third diode and the output capacitor.

20. A method according to claim 16, wherein a terminal of the control switch is connected to ground.
